(19) United States
(12) Patent Application Publication
(10) Pub. No.: US 2010/0065004 A1
(43) Pub. Date: Mar. 18, 2010

(54) Mixture Motion Enhancing Intake Manifold Gasket

(75) Inventors: Jeremy J. Worm, Ahmeek, MI (US); Bryan D. Lehman, Fenton, MI (US); Gary D. Mandrusiak, Lathan, NY (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., DETROIT, MI (US)

(21) Appl. No.: 12/209,669

(22) Filed: Sep. 12, 2008

(51) Int. Cl. F02M 35/104

(52) U.S. Cl. 123/184.53

(57) ABSTRACT

An engine assembly may include a cylinder head, an intake manifold, and a gasket. The cylinder head may define a cylinder head air passage and the intake manifold may be fixed to the cylinder head. The cylinder head may define a intake air passage that is in communication with the cylinder head air passage. The gasket may be located between the cylinder head and the intake manifold. The gasket may include a sealing member and an air flow directing member. The sealing member may be engaged with the cylinder head and the intake manifold to provide sealed communication between the first and intake air passages. The air flow directing member may be in communication with the intake air passage and may extend into the cylinder head air passage to direct an air flow from the intake air passage to a region within the cylinder head air passage.

### FIELD

The present disclosure relates to intake manifold gasket assemblies, and more specifically to controlling air flow with an intake manifold gasket assembly.

### BACKGROUND

The statements in this section merely provide background information related to the present disclosure and may not constitute prior art.

Engines may be designed to provide a variety of air flow conditions. Specifically, intake ports of a cylinder head may be designed to increase air flow for high performance engines or may be designed to generate turbulence for high efficiency engines. These differing design goals result in different cylinder heads for each application, resulting in an increased cost.

### SUMMARY

An engine assembly may include a cylinder head, an intake manifold, and a gasket. The cylinder head may define a cylinder head air passage and the intake manifold may be fixed to the cylinder head. The intake manifold may define a intake air passage that is in communication with the cylinder head air passage. The gasket may be located between the cylinder head and the intake manifold. The gasket may include a sealing member and an air flow directing member. The sealing member may be engaged with the cylinder head and the intake manifold to provide sealed communication between the cylinder head and intake air passages. The air flow directing member may be in communication with the intake air passage and may extend into the cylinder head air passage to direct an air flow from the intake air passage into the cylinder head air passage.

A gasket may include a sealing member and an air flow directing member. The sealing member may include a cylinder head sealing surface and an intake manifold sealing surface and may have a first air flow passage extending through the cylinder head and intake manifold sealing surfaces. The air flow directing member may be coupled to the sealing member and may direct an air flow provided to the cylinder head. The air flow directing member may include a body defining a second air flow passage that extends axially outwardly from the cylinder head sealing surface.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of an engine assembly according to the present disclosure;

FIG. 2 is a schematic plan view of a gasket according to the present disclosure;

FIG. 3 is an additional schematic plan view of the gasket of FIG. 2; and

FIG. 4 is a schematic fragmentary section view of the engine assembly of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

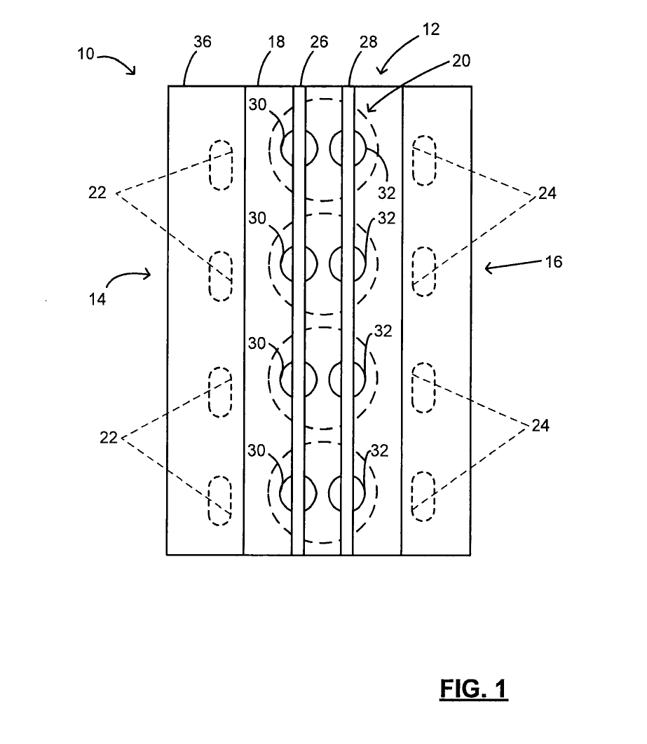

Referring now to FIGS. 1 and 4, an exemplary engine assembly 10 is schematically illustrated. The engine assembly 10 may include an engine 12 and intake and exhaust manifold assemblies 14, 16. The engine 12 may include an engine block (not shown), a cylinder head 18 fixed to the engine block, and a valvetrain assembly 20. The cylinder head 18 may include intake air ports 22 and exhaust gas ports 24.

In the example shown, the valvetrain assembly 20 may include, but is not limited to, intake and exhaust camshafts 26, 28 and intake and exhaust valves 30, 32. The intake valves 30 may be in communication with the intake air ports 22 through a series of cylinder head air passages 34, best shown in FIG. 4. The exhaust gas ports 24 may provide communication between the exhaust valves 32 and the exhaust manifold assembly 16. While the engine assembly 10 is illustrated as an overhead cam engine, it is understood that the present disclosure may be applicable to a variety of other engine configurations as well including cam-in-block engines.

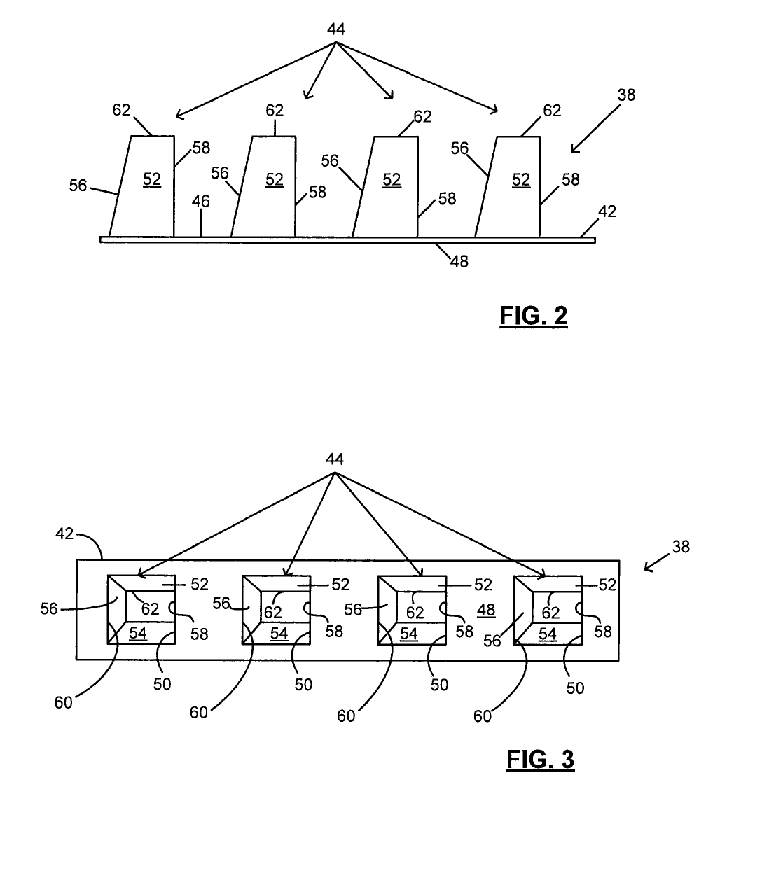

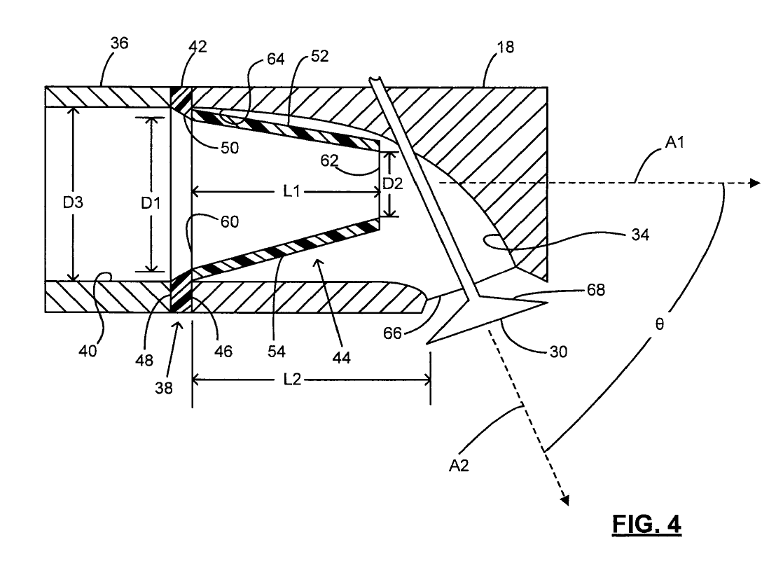

With additional reference to FIGS. 2 and 3 the intake manifold assembly 14 may include an intake manifold 36 and a gasket 38. The intake manifold 36 may define an intake air passage 40 having an outlet in communication with the cylinder head air passage 34 in the cylinder head 18. The gasket 38 may form an intake manifold gasket and may include a sealing member 42 and air flow directing members 44. The sealing member 42 and the air flow directing members 44 may form a single piece. For example, the air flow directing members 44 may be integrally molded with the sealing member 42 or can be separately formed and then attached to the sealing member 42.

The sealing member 42 may include a cylinder head sealing surface 46 and an intake manifold sealing surface 48 having openings 50 that form air flow passages extending through the cylinder head and intake manifold sealing surfaces 46, 48. Each air flow directing member 44 may include a body formed from an upper wall 52, a lower wall 54, first and second side walls 56, 58, an inlet 60 at a first end, and an outlet 62 at a second end. As seen in FIG. 4, the inlet 60 may have an effective diameter (D1) and the outlet 62 may have an effective diameter (D2). An effective diameter may generally be defined as a diameter of a circular opening that approximates the flow restriction of an opening. For example, an effective diameter may include a hydraulic diameter (D_{H}), D_{H}=4A/P where A is the flow area and P is the perimeter of the opening.

The effective diameter (D1) of the inlet 60 may be approximately equal to the effective diameter (D3) of the intake air passage 40. The effective diameter (D2) of the outlet 62 may be less than the effective diameter (D1) of the inlet 60. In the present example, the effective diameter (D2) of the outlet 62 may be at least twenty-five percent less than the effective diameter (D1) of the inlet 60. The outlet 62 may therefore have a flow area that is less than a flow area of the inlet 60.

The upper wall 52, the lower wall 54, and the first and second side walls 56, 58 may be oriented to form a converging nozzle. In the present example, the upper and lower walls 52, 54 may be angled toward one another and the first side wall 56 may be angled toward the second side wall 58. While the air flow directing member 44 is shown as being formed from a series of generally flat walls, it is understood that a variety of other configurations may be used as well, such as a generally conical construction of the body of the air flow directing member 44.

The gasket 38 may be located between the cylinder head 18 and the intake manifold 36. More specifically, the sealing member 42 may be located between the cylinder head 18 and the intake manifold 36 with the cylinder head sealing surface 46 engaged with the cylinder head 18 and the intake manifold sealing surface 48 engaged with the intake manifold 36 to provide sealed communication between the cylinder head and intake air passages 34, 40 through the opening 50 in the sealing member 42, as illustrated in FIG. 4.

The air flow directing member 44 may extend within the cylinder head air passage 34 of the cylinder head 18. The air flow directing member 44 may have an axial extent, or length, (L1) within the cylinder head air passage 34. The cylinder head air passage 34 may define a length (L2) between an inlet 64 and an outlet 66 thereof. The axial extent (L1) of the air flow directing member 44 may be at least twenty-five percent of the length (L2), and more specifically, greater than fifty percent of the length (L2). Additionally, the length (L1) of the air flow directing member 44 may be greater than the effective diameter (D2) of outlet 62 of the air flow directing member 44.

The angled orientation of the upper wall 52, the lower wall 54, and the first side wall 56 may direct an air flow through the air flow directing member 44 toward an inner wall that defines the cylinder head air passage 34 within the cylinder head 18. For example, the outlet 62 of the air flow directing member 44 may be oriented toward an inner wall defining the cylinder head air passage 34. As a result, the outlet 62 of the air flow directing member 44 may be oriented in a first direction (A1) and the outlet 66 of the cylinder head air passage 34 may be oriented in a second direction (A2). The first direction (A1) may be generally perpendicular to a plane defined at the outlet 62 of the air flow directing member 44 and the second direction (A2) may be generally perpendicular to a plane defined at the outlet 66 of the cylinder head air passage 34. The first direction (A1) may be disposed at an angle (θ) relative to the second direction (A2), resulting in the air flow directing member 44 extending away from the outlet 66 of the cylinder head air passage 34. For example, the angle (θ) may be less than 90 degrees.

The arrangement of the air flow directing member 44 within the cylinder head air passage 34 may induce a turbulent air flow. For example, the air flow directing member 44 may assist in directing an air flow toward the valve bowl area 68 of the intake valve 30 in such a way as to increase in-cylinder air flow turbulence. The gasket 38 may be used to modify air flow characteristics within a cylinder head without modifying the cylinder head casting. As a result, common cylinder head designs may be employed where different air flow characteristics are desired by simply using the gasket 38 to modify the air flow properties.

What is claimed is:

1. An engine assembly comprising:
a cylinder head defining a first air passage;
an intake manifold fixed to the cylinder head and defining a intake air passage in communication with the cylinder head air passage; and
a gasket located between the cylinder head and the intake manifold including a sealing member and an air flow directing member, the sealing member being engaged with the cylinder head and the intake manifold to provide sealed communication between the cylinder head and intake air passages and the air flow directing member being in communication with the intake air passage and extending into the cylinder head air passage to direct an air flow from the intake air passage into the cylinder head air passage.

2. The engine assembly of claim 1, wherein the air flow directing member includes an outlet and an inlet, the outlet having an effective diameter that is less than an effective diameter of the inlet.

3. The engine assembly of claim 2, wherein the outlet has a flow area that is less than the flow area of the inlet.

4. The engine assembly of claim 2, wherein the outlet has an effective diameter that is at least 25 percent less than the effective diameter of the inlet.

5. The engine assembly of claim 2, wherein the intake air passage includes a manifold outlet that is in communication with the inlet of the air flow directing member, the manifold outlet having an effective diameter that is approximately equal to the effective diameter of the inlet of the air flow directing member.

6. The engine assembly of claim 1, wherein the air flow directing member includes a body having a first end located proximate the sealing member and having a first effective diameter and a second end generally opposite the first end and located within the cylinder head air passage and having a second effective diameter, the second effective diameter being less than the first effective diameter.

7. The engine assembly of claim 6, wherein the body of the air flow directing member extends a length into the cylinder head air passage, the length being greater than or equal to the second effective diameter.

8. The engine assembly of claim 6, wherein the cylinder head air passage has a first length between an inlet and an outlet of the cylinder head air passage, the body of the air flow directing member extending a second length into the cylinder head air passage that is at least 25 percent of the first length.

9. The engine assembly of claim 6, wherein the body forms a converging nozzle.

10. The engine assembly of claim 6, wherein the body is oriented at an angle within the cylinder head air passage to direct an air flow through the air flow directing member toward a wall of the cylinder head air passage.

11. The engine assembly of claim 10, wherein the body of the air flow directing member extends away from an outlet of the cylinder head air passage in a direction from the first end to the second end of the air flow directing member.

12. The engine assembly of claim 1, wherein the air flow directing member is adapted to induce a turbulent air flow.

13. A gasket comprising:
a sealing member including a cylinder head sealing surface and an intake manifold sealing surface having a first air flow passage extending through the cylinder head sealing surface and the intake manifold sealing surface; and
an air flow directing member coupled to the sealing member that directs an air flow provided to a cylinder head, the air flow directing member including a body defining a second air flow passage and extending axially outwardly from the cylinder head sealing surface.

14. The gasket of claim 13, wherein the body includes a first end proximate the first air flow passage and a second end generally opposite the first end, the first end defining an inlet having a first effective diameter and the second end defining an outlet having a second effective diameter that is less than the first effective diameter.

15. The gasket of claim 14, wherein the outlet has a flow area that is less than a flow area of the inlet.

16. The gasket of claim 14, wherein the outlet has an effective diameter that is at least 25 percent less than the effective diameter of the inlet.

17. The gasket of claim 14, wherein the axially outward extent of the air flow directing member is greater than or equal to the second effective diameter.

18. The gasket of claim 14, wherein the body of the air flow directing member forms a converging nozzle.

19. The gasket of claim 13, wherein the air flow directing member is adapted to induce a turbulent air flow.

20. The gasket of claim 13, wherein the gasket is formed as a single piece member, the air flow directing member being integrally molded with the sealing member.
